(19) United States
(12) Patent Application Publication
(10) Pub. No.: US 2019/0005414 A1
(43) Pub. Date: Jan. 3, 2019

(54) RUBUST DYNAMIC TIME SCHEDULING AND PLANNING

(71) Applicant: OPTIBUS LTD, Netanya (IL)

(72) Inventor: Amos HAGGIAG, Netanya (IL)

(21) Appl. No.: 16/060,536

(22) PCT Filed: Aug. 12, 2016
(86) PCT No.: PCT/IL2016/050884

§ 371 Date: Jun. 8, 2018

Related U.S. Application Data
(60) Provisional application No. 62/203,934, filed on Aug. 12, 2015.

(51) Int. Cl. G06N 99/00; G06N 5/02; G06N 7/00; G06Q 10/06; G06Q 10/10; G07C 5/00; G06Q 50/30

(52) U.S. Cl. CPC G06N 99/005; G06N 5/025; G06N 7/005; G06Q 50/30; G06Q 10/109; G07C 5/008; G06Q 10/0631

(57) ABSTRACT

The present invention relates to offline and/or real time scheduling systems. In particular, the present invention relates to offline and/or real time transportation scheduling. More specifically, the present invention relates to novel improvements in transportation planning and allocation of resources on a offline and/or real time basis including: a client interface, an offline and/or real time data processor for creating a prediction, an optimization engine electronically attached to the client interface and the offline and/or real time data processor for readily producing a new schedule, and a transportation means electronically attached to the optimization engine and responsive to the new schedule.

### FIELD OF THE INVENTION

The present invention relates to offline and/or real time scheduling systems. In particular, the present invention relates to offline and/or real time transportation scheduling. More specifically, the present invention relates to novel improvements in transportation planning and allocation of resources on a offline and/or real time basis.

### BACKGROUND OF THE INVENTION

According to contemporary teachings of the art, a dispatcher, will often need to address one or more cases when the planned schedule cannot be met due to events that occur in real-time. Such events will typically include, by way of non-limiting examples only, heavy traffic causing delays, vehicular break downs and unpredicted demand.

Invariably, such events bring about an undesired result of at least one vehicle and/or driver are not to being able to meet with a planned schedule for that vehicle of a fleet of vehicles.

Thus, any such vehicle being late, can bring about a further undesired outcome of delaying the next planned activity for that vehicle, line, fleet and the like.

Attempted solutions known in the art include, among others, AVL (automatic vehicle location) systems for indicating a “current location” of the vehicles.

Some attempted solutions will automatically notify that a vehicle is going to be late. Nevertheless, the systems known in the art do not offer an automatic rescheduling solution.

Moreover, a further latent deficiency of the systems known in the art is their lack of calculating planning restriction preferences and costs as an integral part of a rescheduling.

A further still latent deficiency of systems known in the art is their inability to “preempt” an event based on statistical modules and/or according to electronic signals of a “learning module”.

The existing scheduling systems offer offline scheduling which often take at least several hours or even days to create a new schedule and do not offer any real-time rescheduling system and especially none with an integrated with an AVL solution.

The current attempted solutions known in the art, include a dispatcher becoming aware there is a problem with a given schedule of a specific vehicle, line or fleet, and then attempts to “manually” reschedule the vehicles and drivers to address the issue. A latent deficiency of any such attempt is the limited calculative resources and limited parameters a human dispatcher can address.

It is well known in the art that a dispatcher, in attempting to resolve a offline and/or real time scheduling dilemma, may opt to break regulations and/or offer a partial and/or inadequate solution which is far from optimal.

Even though one can find many control rooms with monitors that display the location of vehicles and in some cases display whether they are on time or going to be late to their next trip, once an indication is received that a vehicle is predicted not to perform a specific task within the time slot allocated thereto, it is up to the dispatcher to handle such an occurrence by either accepting a delay or seeking to find an alternative solution utilizing the available resources of vehicles and/or drivers to replace and/or augment the delayed vehicle in completing the given task or at least one of the subsequent tasks according to the original schedule.

A latent deficiency of the attempted solutions known in the art is the inability of creating a schedule in advance that will be robust enough to substantially avert the need to change schedules on a real and/or offline basis.

Scheduling of transit companies determines the allocation of resources to tasks, where resources usually are vehicles and drivers, and tasks are service trips (e.g. bus/train routes). Traditionally, scheduling is done once every few months, or once a year, and is changed only when major changes in the network are required (e.g. additional route, changes in timetable, etc.). However, transportation networks are dynamic in nature, and the time it takes to get from point A to B can change radically throughout time, due to many factors (e.g. roads are busier on certain days, accidents, road jams on certain hours, yearly seasons etc.). Any such change in the duration of trips, can result in a schedule that is not suitable for the actual network .

For example, trip from A to B that depart at 10:00, takes 60 minutes when the schedule was created (i.e. arrives at 11:00 to B), the scheduler links this trip to another trip from B to A that starts at 11:05, which means the vehicle that completed the trip from A to B continues to the trip from B to A 5 minutes later. A month later due to changes in network (e.g. increased traffic jam) the trip takes 70 minutes. This immediately results in a schedule where the trip from B to A is delayed in 5 minutes. This results in a bad service, fines, and possible loss of contract with the operator.

Any such change requires the operator to rebuild the schedule. However, rebuilding the schedule is an expensive operation; it requires changing the driver shifts, rosters, vehicle schedule, etc. Such changes can result in compensation payments to drivers, and in general can result inferior schedule if not done correctly. Thus, operators try to avoid such changes as much as possible, although they are imminent.

This invention aims to solve these issues by creating “robust schedules” which are resistant to such changes, reducing the number of schedule changes that an operator needs to deploy, without increasing the cost of the schedule more than needed.

Operators today tries to reduce the number of schedule changes, by using BI tools to estimate the travel time for each day/time of each trip using historical information on the network. After this manual procedure a timetable is generated, which uses averages to travel times, from which schedule is created. To avoid possible deviations from the schedule, recovery time is usually added to each trip, which practically adds few minutes to each trip so that small delays can be tolerated. However, the impact on the cost of the schedule is huge, and can result in addition of multiple vehicles, drivers, and overall increase of costs in paid hours. In addition, schedules are not protected against major deviations that can be predictable.

There is therefore a latent need to find a suitable robust alternative solution in a very short time frame and preferably on a substantially offline and/or real time scheduling basis, as well as substantially contemporaneously addressing a wide range of changing and cross linked variables, different regulations, constraints and the challenge minimizing or wasting any resources.

Latent deficiencies commonly encountered by systems known in the art will often include: violations of operator rules, preferences, and regulations due to un-guarded changes; incurring delays for passengers due to the need to provide a solution in a short time period and non-optimal solution which results in inflated fleets, among others, due to large reserves being required, wasted costs and pollution due to the complexity of the problem that needs to be solved in a short time period.

### SUMMARY OF THE INVENTION

The present invention is a robust dynamic scheduling and planning system.

### BRIEF DESCRIPTION OF THE DRAWINGS

FIG. 1 is a block diagram view of the robust dynamic scheduling and planning according to the present invention.

### DETAILED DESCRIPTION OF THE INVENTION

The robust dynamic scheduling and planning according to the present invention, as described herein, readily facilitates updating/editing on a substantially “offline and/or real time” basis and devoid of violations of operator rules, preferences, and regulations due to un-guarded changes; incurring delays for passengers due to the need to provide a solution in a short time period and non-optimal solution which results in inflated fleets, among others, due to large reserves being required, wasted costs and pollution due to the complexity of the problem that needs to be solved in a short time period.

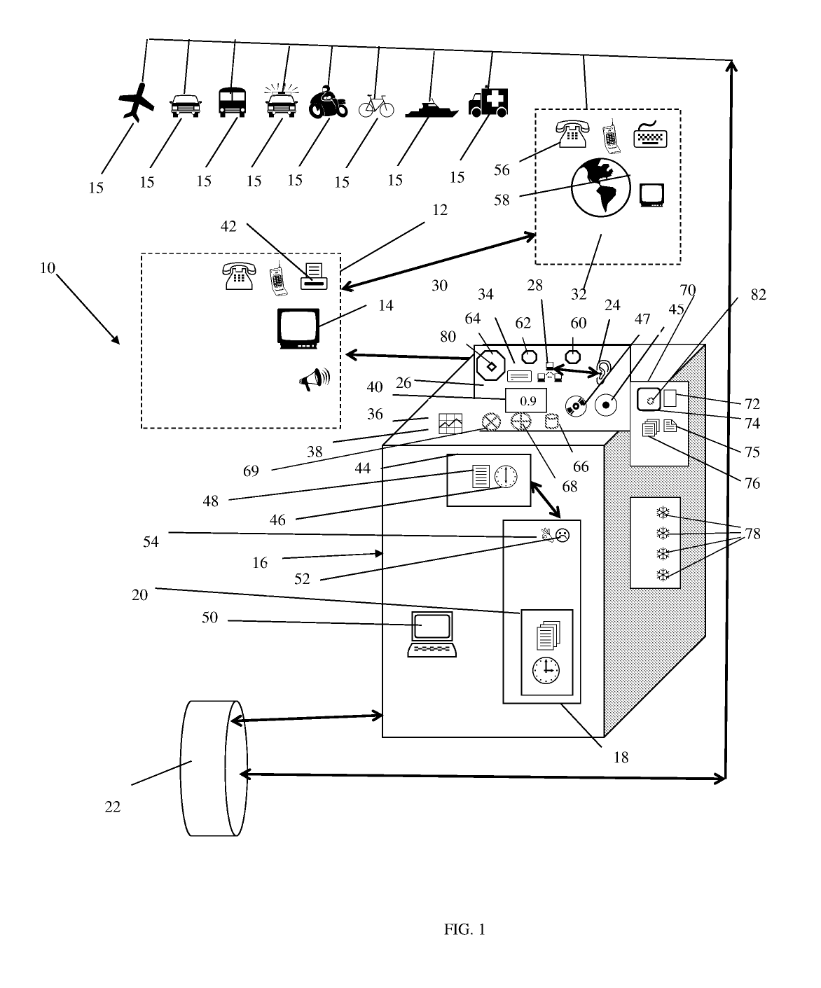

As shown in FIG. 1, a robust dynamic scheduling and planning 10 according to the present invention includes a client interface 12, wherein client interface 12 is preferably displayed as a Gantt chart. Optionally, client interface 12 includes at least one map display 14 for readily displaying the location of at least one transportation means 15.

Robust dynamic scheduling and planning 10 preferably includes an optimization engine 16 and a data set 18, wherein data set 18 preferably includes an existing schedule 20 and historical data including the actual travel time of historical trips.

Optionally, at least one map display 14 readily displaying the location of at least one transportation controller 22, wherein transportation controller 22 controls transportation means 15 either remotely or locally. By way of an unlimiting example only, transportation controller 22 may be the driver of transportation means 15.

Robust dynamic scheduling and planning 10 preferably also includes a real-time data listener 24 and a prediction engine 26.

Alternatively, client interface 12 also includes a real-time data listener 24 and a prediction engine 26.

Alternatively, optimization engine 16 also includes a real-time data listener 24 and a prediction engine 26.

Preferably, dataset 18 including historical data is fed into prediction engine 26, wherein preferably, a multiplicity of data points that are including for readily improving prediction accuracy.

By way of example only, prediction engine 26 predicts for each trip in each day of existing schedule 20, at least one prediction selected from the group consisting of: a 99% travel time prediction, a 95% travel time prediction, 90% travel time prediction, 80% travel time prediction, 75% travel time prediction.

Optionally, actual percentages are readily configurable. Preferably, a percentage P represents travel time wherein the probability that a trip will conclude before that time is P.

By way of example only, a travel time of 45 minutes in 75% represents that prediction engine 26 predicts that there is a probability of 75% (for the specific trip) that transportation means 15 will be able to complete the trip in 45 minutes or less.

Preferably, optimization engine 16 receives dataset 18 which dataset 18 preferably includes predicted travel times. Preferably, optimization engine 16 calculates a new schedule 46 including optimal scheduling for controllers 22 and transportation means 15 that use the travel time predictions 36 and cost parameters to optimize the expected cost of the schedule.

Preferably thereafter new schedule 46 is then published to at least one dispatcher 50.

Optionally, during each work session of executing existing schedule 20, a real-time feed 28 from at least one transportation means 15 is continuously fed into the real-time data listener 24 as a stream of data 30.

Stream of data 30 preferably contains a raw positioning data 32, real time feed 28, or a processed data 34 for transportation means 15.

Thus, permutations according to raw positioning data 32, real time feed 28, or a processed data 34 for transportation means 15 are readily calculated for the purpose of proactive analysis of transportation means 15 meeting schedule 20.

Prediction engine 26 is preferably responsive to raw positioning data 32 being received, whereupon raw positioning data 32 is passed to prediction engine 26 for processing and calculating the probability of transportation means 15 not meeting the time frame allocated thereto in existing schedule 20.

Preferably, prediction engine 26 creates a prediction 36 based on raw positioning data 32 being received, dataset 18 including historical data and passed to prediction engine 26 on transportation means 15 meeting or not meeting the time frame allocated thereto in existing schedule 20.

Preferably, prediction engine 26 will accumulate and provide data on the accuracy of probability calculations compared to actual performance of transport means 15 according to existing schedule 20.

Preferably, prediction engine 26 includes a plurality of prediction models 45 and a history data 47 as optional parameters and/or fine tuning prediction 36.

Preferably, prediction engine 26 predicts in high accuracy the probabilities for a trip to be completed within a certain time frame. For the purpose of achieving improved probabilities of a trip, prediction engine 26 preferably includes at least one module selected from the group consisting of: a data cleansing module of historical travel times 60, a feature extraction module 62 and model training module 64.

Preferably, data cleansing module of historical travel times 60 includes at least one incorrect measurement 66 due to errors in AVL (automatic vehicle location system) signals and wherein data cleansing module 60 preferably removes or corrects such incorrect measurements 66 by inspecting feasibility of at least one of a plurality of first measurements 68 compared to at least one second measurement 69 of the same trip/route. By way of example only, a trip can take 60 minutes every day but on one day it took 7 minutes, which is rejected as unacceptable data based on possible speeds and other capabilities of transportation means 15 thus bringing about a removal of the 7 minute trip from the dataset 18.

By way of an example only, feature extraction module 62 extracts at least one of the following features from each measurement: a temporal feature such as day of week, month, season, holiday, time, hour, time period (morning/evening/afternoon), speed, a spatial features such as route identification, route sign, route direction, origin location, destination location, major locations in-route, a demand feature such as expected passenger load for the day, expected passenger load for the route, expected passenger load for the time , expected passenger load for the trip, a vehicle feature such as vehicle type, average vehicle speed, max vehicle speed, vehicle passenger capacity, average vehicle capacity and a relative feature such as time of previous trip of the same route and direction, time in other direction, speed of routes of the same vehicle type and speed of routes with the same expected passenger capacity.

Preferably, model training 64 logs historical data measurements 70 wherein each historical data measurement 70 includes specific features derived subsequent to a feature extraction stage 72, computes a prediction model 74 and prediction scoring 75.

Preferably, prediction model 74 is geared towards being used to predict travel time of trips.

Preferably, prediction model 74 includes at least one supervised machine learning algorithms 76 for readily boosting a plurality of decision trees 78. Due to the large number of features, high number of data points, and the type of prediction values, optionally, additional calculation modules can be used, including but not limited to Naïve Bayes, Support Vector Machines, Neural Networks, among others.

Preferably, within training module 64, each measurement actual travel time is not used as a feature, and only the extracted features are used. Training module 64 is trained for a given day, using all the measurement that exists up to that day and not including same day, or days that come after same day (in the future). The target variable for each measurement is the actual travel time.

Preferably, training module 64 creates a training model 80 wherein training model 80 is evaluated in comparison a given day including actual travel times. Substantially subsequently thereafter, this process is repeated on random days, where on each day training model 80 is added to dataset 18 thus readily facilitating the result of all these days to be measured.

Occasioning on major deviations in predictions being determined, the parameters of training module 64 (e.g. tree cut bounds, learning rate, etc.) are tuned, thereby “robusting” prediction model 74.

Preferably, this process of training module is repeated daily, preferably utilizing large data jobs of Map-Reduce on distributed clusters, such as Apache Hadoop, or similar.

Preferably, prediction scoring 75 substantially subsequently to completing a cycle of training module 64, prediction scoring 75 receives an updated prediction model 74 for readily predicting the travel time.

Prediction model 74 preferably includes at least one decision tree 82 for producing a plurality of different predictions for different travel times, wherein each one is associated with an assigned probability.

The implementation of prediction module 74 and prediction scoring 75 depends on the actual algorithm selected for training.

By way of example only, a case of the boosted trees algorithm, the prediction scoring flow would include the steps of:
(i) computing features for all trips in the day;
(ii) feeding each feature vector (single trip features) through the decision tree, using each tree node boosted features as a predicate to choose between tree branches wherein the tree leafs preferably represent an actual probability and a travel time and multiple leafs are used to select different probabilities based on different travel times.

Preferably, prediction 36 includes of an expected arrival time 38 with a confidence score 40 (probability between 0 and 1), and an expected impact 42 by knowing how many passengers are expected to be on the next trip using statistical history.

Occasioning on prediction 36 of an expected arrival time 38 not meeting existing schedule 20 from an external feed (not shown in FIG. 1) and/or the prediction 36, the expected impact 42 is calculated and the client interface 12 is notified and displays an alert with the nature and details pertaining to transportation means 15 not meeting existing schedule 20.

Optionally, prediction engine 26 utilizes an expected arrival time 38 from an external feed (not shown in FIG. 1) to compare to existing schedule 20, the expected impact 42 and/or prediction 36 and client interface 12 is notified and displays an alert with or without the nature and details pertaining to transportation means 15 not meeting existing schedule 20.

Optimization engine 16 is responsive to a request for a rescheduling and all the related information in data set 18.

The information in dataset 18 mainly contains the existing schedule 20, the current location and/or raw positioning data 32 of transportation means 15 the expected arrival time 38 (both late and early), actual travel time of historical trips, transportation controllers 22 and relevant planning constraints and preferences.

Optimization engine 16 creates at least one alternative 44 of a new schedule 46 based on existing schedule 20 which addresses delays compared to existing schedule 20.

Preferably, optimization engine 16 is responsible for creating new schedules 46 schedules for transportation means 15 and/or controllers 22, based on constraints and preferences that the client provide or entered through client interface 12.

Preferably, optimization engine 16 tries to optimize the total algorithmic cost of new schedule 46 which new schedule 46 includes the actual cost of the schedule+penalty cost which is based on the preferences of the client.

Robust dynamic scheduling and planning preferably adds another layer to optimization engine 46 by way of the uncertainty of the actual cost and the schedule feasibility (satisfaction of constraints); actual cost depends on the paid time for controllers 22 and cost of transportation means 15 among others, which also depends on the actual travel time of each trip.

Since the actual travel time depends on predictions, there is some uncertainty in the cost. In addition, constraints uses the travel time as parameters. By way of example only, a transportation means 15 and/or controller 22 cannot perform the trip that starts at 9:00 after a trip that ends at 9:10, and due to uncertainty in travel time there is uncertainty in the feasibility of the schedule.

Thus, optimization engine 46 uses prediction engine 26 to incorporate the uncertainty in travel time to the schedule, in the following way:

Each trip is scored using prediction engine 26 to get probability for several travel time buckets;

Occasioning on evaluating each pair of trips connection feasibility, a penalty is added based on the following formula:

Penalty(trip1, trip2)=Probability(trip2 starts before trip1)×Penalty(delay)

Wherein penalty (delay) is a function that receives the expected delay between the trips, and penalizes connections with higher delay. Exponential function is used to penalize in higher ratios higher delays. When the delay crosses off a predefined threshold the connection is allowed only if the probability of the delay is low enough. By way of example 5%.

When evaluating a duty, a penalty is added based on the following formula:

Penalty(duty)=Probability(duty violates a constraint)×Penalty(violation)

Wherein Probability (duty violates a constraint) is calculated differently depends on the constraint. For example, for constraint of maximum duty work time, the probability that the duty will have more work time than the maximum is calculated, using each trip travel time probabilities with the assumption of independencies between trips for simplicity.

Penalty (violation) is a function that receives each constraints violation with the actual violation and penalizes the duty, preferably with an exponential penalty function.

When the violation crosses a predefined threshold, the duty is only allowed if the probability of the violation is low enough such as 5% for example.

After penalties are added to trip connections, vehicle and duty candidates, the optimization engine runs and optimizes the sum of costs+sum of penalties for the schedule.

Preferably, client interface 12 displays alternatives 44 to be selected by a dispatcher 50, controller 22 or equivalent thereof. Preferably, dispatcher 50 chooses whether to accept one or none of alternatives 44 according to the expected impact 42 and/or nature of the delay and initiates execution of new schedule 46 selected.

Optionally, controller 22 selects one or none of alternatives 44 and initiates execution of new schedule 46 selected.

Optionally, albeit schedules being created in advance, dispatcher 50 does not create new schedule 46 and relies on the robustness of the system to preempt an “event” by producing notification 36 based on based on statistical modules and/or according to electronic signals of a “prediction engine 26.

It is envisaged that predictions 36 should be with high probability of substantially above 50% way in advance to have time notifying all the relevant controllers 22 and transportation means 15 about their changes due to new schedule 46.

Optionally, it is envisaged that predictions 36 should be with high probability of substantially above 90% way in advance to have time notifying all the relevant controllers 22 and transportation means 15 about their changes due to new schedule 46.

For the purpose of providing an advanced and/or accurate prediction 36, prediction engine 26 requires to process stream of data 30 including events and apply prediction models 45 to offer predictions 36 substantially on a real-time basis.

Preferably, using distributed in memory streaming processes, in memory streaming processor 26, together with a model 45 from pre-trained on history data 47, model 45 is fine-tuned and updated in a batch process from the real-time stream of data 30 using machine learning algorithms known in the art.

Preferably, Optimization engine 16 is electronically attached to or integrally formed with dataset 18, which dataset 18 preferably includes a plurality of operator planning restrictions 52, actual travel time of historical trips, existing schedule 20 and planning preferences 54 for readily calculate a few rescheduling alternatives 44 in order for the result to be applicable.

Preferably, Optimization engine 16, creates rescheduling alternatives 44 utilizing dataset 18.

Preferably, real-time data listener 24 is an endpoint that listens to real-time feed of transportation means 15 and the raw positioning data 32 of transportation means 15 as well as processed data 34, and transfers raw positioning data 32 and/or processed data 34 to prediction engine 26.

Preferably, prediction engine 26 processes the real-time feed of stream of data 30, raw positioning data 32 and/or processed data 34.

Preferably, prediction engine 26 applies prediction models 45 on stream of data 30, raw positioning data 32 and/or processed data 34 combining with additional data sources such as traffic reports and the like.

Preferably, prediction engine 26 also keeps training and fine-tuning prediction model 45 using the accumulated data.

Occasioning on an expected impact 42 indicating a delay is predicted with high probability and of a high magnitude, preferably, client interface 12 indicates the delay and/or optimization engine 16 for a new schedule 46 and/or an alternative 44 to be calculated bearing in mind related and/or relevant expected times of arrival 38, predictions 36, models 45, history data 47, operator planning restrictions 52 and planning preferences 54.

Substantially thereafter, prediction engine 26 sends the relevant dataset 18 to optimization engine 16 and substantially thereafter optimization engine 16 relays for new schedule 46 to client interface 12.

Preferably, upon client interface 12 receiving a prediction 36 of a transportation means 15 not meeting an expected time of arrival 38 according to existing schedule 20, client interface 12 displays a notice and notifies dispatcher 50 about the expected delay of transportation means 15.

Preferably, upon client interface 12 receiving a prediction 36 of a transportation means 15 not meeting an expected time of arrival 38 according to existing schedule 20, client interface 12 displays new schedule 46 and/or new expected times of arrival 48 to dispatcher 50.

Upon client interface 12 receiving a prediction 36 of a transportation means 15 not meeting an expected time of arrival 38 according to existing schedule 20, client interface 12 displays information selected from the group consisting of: which part or existing schedule 20 is expected not to be met, raw positioning data 32 pertaining to transportation means 15 effected and other relevant transportation means 15.

Upon client interface 12 receiving a new schedule 46 and/or an alternative 44, from optimization engine 16, client interface 12 displays to dispatcher 50 at least one of the parameters selected from the group consisting of: a new schedule 46 and/or an alternative 44 thereby readily facilitating dispatcher 50 to select and/or execute a new schedule 46 and/or an alternative 44.

Preferably, occasioning on optimization engine 16 receiving a request for creating a new schedule 46, the relevant arrival predictions 36, optimization engine 16 initiates a new rescheduling process which preferably includes the following steps:
a. Parsing dataset 18 with at least one of parameters selected from group consisting of history data 47 activity for transportation means 15, planning preferences 54, planning constraints 52 and arrival predictions 36.
b. Removing from existing schedule 20 tasks of transportation means 15 effected by the delay prediction 36.
c. Starting an iterative process for rescheduling the effected tasks to other transportation means 15 and/or transportation controllers 22 (including reserve transportation means 15 and/or reserve transportation controllers 22) substantially contemporaneously with calculating and producing a cost efficient new schedule 46. Preferably, optimization engine 16 prioritizes locations that minimize disruption of tasks already in existing schedule 20, and from those to most efficient ones.
d. Occasioning on such a location not being available, optimization engine 16 will preferably calculate impact 42 of using a new transportation means 15 or replacing an existing task in existing schedule 20 effected by expected time of arrival 38 of prediction 36, and move and/or relocate the replaced task to the reschedule process as part of new schedule 46.
e. Preferably, optimization engine 16 creates a new schedule 46 and/or new expected times of arrival 48 according to preferences 54 and constraints 52.
f. Preferably, optimization engine 16 calculates new schedule 46 and/or new expected times of arrival 48 substantially contemporaneously with a plurality of prediction models 45 thereby creating a plurality of predictions 36 and/or new schedule and branching into a tree of feasible alternatives.
g. Preferably and occasioning on optimization engine 16 completing calculations of pertinent new schedules 46 and/or new expected times of arrival 48, optimization engine 16 transfers new schedules 46 and/or new expected times of arrival 48 to client interface 12 with detailed cost changes and/or impact 42 on existing schedule 20.

Preferably, real time data listener 24 is a passive component which real time data listener 24 receives raw positioning data 30.

Preferably, prediction engine 26 is responsive to receiving processed data 34, and/or expected times of arrival 38 and/or predictions 36 of existing schedule 20 is expected not to be met.

Preferably, real time data listener 24 receives traffic updates from sources of traffic updates known in the art and/or external sources.

In operation, real time data listener 24 preferably transfers to prediction engine 26 at least one of the parameters selected from the group consisting of: raw positioning data 30, processed data 34 with expected times of arrival 38 and predictions 36 of existing schedule 20 is expected not to be met.

By way of example only, predictions 36 of a 10 minute delay is calculated for transportation means compared to existing schedule 20. Thereafter, robust dynamic scheduling and planning 10 checks whether existing schedule 20 can be optimized, the specific task can be optimized by changing route or not just the specific task being performed by the transportation means 15, thus readily addressing and substantially circumventing patterns of escalation in dataset 18.

Alternatively, robust dynamic scheduling and planning 10 checks whether changing the allocation of resources and/or augmenting with assets can minimize or negate prediction 36 of expected times of arrival 38 according to existing schedule 20 not being met. Thus, preferably robust dynamic scheduling and planning 10 continuously calculates, changes and adapts prediction 36 with alternating values, thereby providing a solution and/or optimizing results to reach or exceed a delay value of zero minutes or less (meaning arriving “ahead of time”).

Preferably, if a score 40 of at least 50% probability of a 5 minute delay from expected times of arrival 38 according to existing schedule 20 are reached, robust dynamic scheduling and planning 10 checks whether existing schedule 20 can be optimized.

Preferably, if a score 40 of 50% probability of 5 m delay from expected times of arrival 38 according to existing schedule 20 are reached, robust dynamic scheduling and planning 10 checks whether existing schedule 20 for entire day can be optimized and not just the specific task being performed by the transportation means 15, thus readily addressing and substantially circumventing patterns of escalation in dataset 18.

Preferably, if 50% probability or 5 m delay from expected times of arrival 38 according to existing schedule 20 are reached, robust dynamic scheduling and planning 10 checks whether changing the allocation of resources and/or augmenting with assets can minimize or negate prediction 36 of expected times of arrival 38 according to existing schedule 20 not being met.

Preferably, calculation of new schedule 46 and/or new expected times of arrival includes number of passengers according to history data 47, thereby further fine tuning new schedule 46.

Preferably, according the embodiments and description of robust dynamic scheduling and planning 10 according to the present invention, of robust dynamic scheduling and planning 10 System is both reactive and proactive with regard to predictions 36 and impact 42.

Preferably, transportation means 15 includes a telemetry subsystem 56 for transferring telemetry data 58 regarding the transportation means 15 on a substantially real-time basis.

Preferably, telemetry data 58 includes at least one parameter selected from the group consisting of: a weather condition, a raw positioning data 32, a speed, a tire pressure, an oil pressure, a G force in 3 axis, a tire rate of deterioration, an acceleration rate, an oil temperature, a water temperature, an engine temperature, a wheel speed, a suspension displacement, controller 22 information, a two way telemetry transmission for remote updates, calibration and adjustments of a component of transportation means 15, expected tire change required, expected refueling required and an expected servicing required.

By way of example only, prediction 36 can produce a new planning restriction 54 due to a scheduled and/or required maintenance, pit stop, refuel, and tire change and the like.

The term “transportation means ” as used herein, shall include but will not be limited to: a means of conveyance or travel from one place to another including a vehicle or system of vehicles, such as a bus, a train, a ship, a boat, a taxi, a car, an automobile, a two and three wheeled vehicle, a sea vessel, an aircraft or an airborne carrier and the like for private and public conveyance of passengers or goods especially as a commercial enterprise, a means of transportation, a controller of a means of transportation, a bank energy resource for a means of transportation, a loading station for loading a means of transport, an off-loading station for off-loading a means of transport and the like.

It will be appreciated that the above descriptions are intended to only serve as examples, and that many other embodiments are possible within the spirit and scope of the present invention.

What is claimed is:

1. A robust dynamic scheduling and planning comprising:
(a) a client interface;
(b) a offline and/or real time data processor for creating a prediction
(c) an optimization engine electronically attached to said client interface and said offline and/or real time data processor for readily producing a new schedule; and
(d) a transportation means electronically attached to said optimization engine and responsive to said new schedule.

2. The robust dynamic scheduling and planning of claim 1, further comprising a dataset including at least one parameter selected from the group consisting of: a plurality of tasks, a history dataset containing the actual travel time of historical trips, a prediction model, a planning constraint and a planning preference.

3. The robust dynamic scheduling and planning of claim 2, wherein said client interface further comprising a controller.

4. The robust dynamic scheduling and planning of claim 3, wherein offline and/or real time data processor is responsive to a set of telemetry data, wherein telemetry data includes at least one parameter selected from the group consisting of: a weather condition, a raw positioning data, a speed, a tire pressure, an oil pressure, a G force in 3 axis, a tire rate of deterioration, an acceleration rate, an oil temperature, a water temperature, an engine temperature, a wheel speed, a suspension displacement, a controller information, a two way telemetry transmission for remote updates, calibration and adjustments of a component of transportation means, expected tire change required, expected refueling required and an expected servicing required.

5. The robust dynamic scheduling and planning of claim 1, further comprising a prediction engine for readily “preempting” an event based on statistical modules processing a stream of data and/or a learning process of said prediction engine.

6. The robust dynamic scheduling and planning of claim 2, further comprising a training module.

7. The robust dynamic scheduling and planning of claim 5, wherein said optimization engine is responsive to signals from said prediction engine.
